(19) United States
(12) Patent Application Publication
(10) Pub. No.: US 2007/0192185 A1
(43) Pub. Date: Aug. 16, 2007

(54) Method for selling goods and services by association via cocast content

(76) Inventor: Fathy Yassa, (US)

Correspondence Address: The Farrow Law Firm;Suite 50, 3031 Tisch Way, San Jose, CA, 95128, US

(21) Appl. No.: 11/355,926

(22) Filed: Feb. 15, 2006

(51) Int. Cl. G06Q 30/00; A63F 13/00

(52) U.S. Cl. 705/14; 463/32

(57) ABSTRACT

An exemplary method and apparatus for co-casting advertisements for the sale of advertising and other content via broadcast medium.

### CLAIM OF PRIORITY

This Application claims priority from USPTO provisional application No. 60/441,671 filed on Jan. 21, 2003 and provisional application No. 60/441,672 filed on Jan. 21, 2003 and incorporates said applications by reference as if fully set forth herein.

### BACKGROUND

The invention herein disclosed describes an exemplary revenue management system (RMS) for selling goods and services via association with the content that a subscriber receives via a television or other display device such as computer monitor.

### DESCRIPTION OF THE PRIOR ART

Traditionally, television and radio advertisers pay marketing and research companies' substantial sums of money to research and determine the likes and dislikes of various demographic groups, and whether a particular demographic group is likely to enjoy a particular show. Based upon this information, content studios can create and market various shows which will ostensibly appeal to the target demographics. Demographic information may include, age, socio-economic status, gender, religion, and/or ethnicity. Rating companies such as the Nielsen's are then employed to determine the various statistics behind the audience of each show. Such statistics include total number of viewers, and the actual demographic breakdown of the audience.

For example makers of athletic gear have traditionally targeted young, male, affluent audiences and purchased advertising space on television shows that attract the advertisers' target audience(s).

Such advertising has proven to be an effective method of increasing market share and accordingly revenue. However, consumers have resisted permitting advertisers to continually increase advertising time at the expense of content. Therefore only a limited number of advertisements may run during a particular time slot. Further, all viewers of a given show, even those uninterested in the product, see the same television ads, thus wasting valuable airtime. For purposes of this discussion, television and television signals include radio and radio signals.

### SUMMARY OF THE INVENTION

The exemplary invention disclosed herein related to a method of selling advertisements which are personalized to the end-user's taste and delivering said advertisements and multi-media content simultaneously to different end-users; to wit fractional advertising via co-casting. For purposes of this discussion, co-casting means the transmission of one or more secondary television signals along with a primary signal such that the secondary signals do not interfere with the viewable portion of the primary television signal.

### DETAILED DESCRIPTION

The RMS herein disclosed solves these issues by sending advertisements to one or more devices such as a traditional television, or directly to a wired or wireless device such as any hand held wireless device. The RMS is particularly novel in that different subscribers may see different advertisements, at the same time, thus permitting the purchasers of advertising to further refine the targeting of their audiences.

Traditionally, advertising is charged based upon the number of viewers and the desirability of the viewers. Similarly, the exemplary RMS uses these criteria as well as the data obtained regarding the viewership of various television shows to determine fractional pricing for one or more advertisers such that multiple advertisers can advertise simultaneously, yet reaching different viewers. This increases the number of potential advertisers.

In the current embodiment, the RMS determines advertisement charges based upon the number of anticipated viewers and the general desirability of said viewers. the RMS provides several alternative means of purchasing advertising. Specifically, the RMS permits an advertiser to purchase advertising space on the wireless device by the number occurrence of a trigger event within the content itself, the time the advertisements are to be sent to the wireless device, the subscriber marketing preferences, or any combination of the above.

In one embodiment of the invention, the RMS charges a flat fee for sending advertisements during content. The flat fee would be primarily influenced by the frequency that the advertisement should be sent.

Alternatively, the purchaser could reduce costs by sending the advertisement only to those persons who are watching a certain program. The RMS discounts the pricing because said arrangement frees that time for other advertisers.

In a further embodiment, the RMS would permit the purchaser to limit the advertisement to those persons who have affirmatively stated a desire to receive solicitations from within the purchaser's industry. This again reduced the number of potential recipient subscribers. The RMS would recognize these viewers as highly desirable and charge a premium accordingly.

In additional to selling static advertisements, the RMS would also permit the purchaser to insert hypertext links so that the subscriber may immediately go to the advertisers web site and receive more information or order products. An additional charge would apply.

The RMS also permits revenue from the end-user. Specifically, the end-user may purchase additional content to be sent to the receiving device. The RMS permits several pricing options for this content including various levels of subscriptions. For example, a user may opt to automatically receive content based upon a pre-determined set of criteria; alternatively, the end-user may decide on a case by case basis to purchase the content. Further, a different user may choose only to accept content that the content providers gives away freely, while another user may opt out altogether.

In another embodiment of the invention, the content is related to the television content. The end-user uses one or more of the subscription methods to receive content. For example, an end-user may request all recipes be send to the wireless device.

In yet another embodiment of the invention, the content is related to travel locations. Specifically, the tracking system of cell phone relays said information to the invention that sends content based upon your travel habits. Such content might include, traffic and weather information, dining options, etc.

In one embodiment of the invention, the content is transmitted via satellite or cable-TV through a television set-top box configured to transmit wirelessly. In another embodiment, the content is transmitted via the internet.

In yet another embodiment, the content is encoded and transmitted in a static distribution media such as DVD-ROM, CD-ROM, or a dynamic distribution media such as personal video recorder, magnetic hard drives, and writeable or re-writeable CD's and DVD's

In a further embodiment of the invention, the content is transmitted via cellular service.

In the current embodiment, the content can be transmitted using any wireless protocol.

Though the present invention has been described with reference to a preferred embodiment thereof, it will be understood that the invention is not limited to the details thereof. Various modifications and substitutions have been suggested in the foregoing description, and others will occur to those of ordinary skill in the art. All such substitutions are intended to be embraced within the scope of the invention as defined in the appended claims.

We claim:

1. A revenue management system (RMS) designed to sell fractional advertising time comprising the steps of determining the end-user's viewing habits and content preferences, transmitting advertisements to the one or more receiving units based upon said end-users viewing habits and content preferences, and charging for the advertising time based upon the number of end-users who received the advertising.

2. The RMS of claim 1 where the RMS determines pricing information based upon the type of device the advertisements are transmitted to.

3. The RMS of claim 2 where the advertisement is transmitted to a television set.

4. The RMS of claim 3 where the advertisement is transmitted to a wireless device.

5. The RMS of claim 3 where the advertisement is transmitted via e-mail.

6. The RMS of claim 1 where the advertisements are embedded in the television signal by the content distributor.

7. The RMS of claim 1 where the advertisement is embedded in a removable media device.

8. The RMS of claim 1 where the charges are based upon the number of times an advertisement is sent to a receiving device.

9. The RMS of claim 8 where the number of times an advertisement is sent to a receiving device is pre-determined.

10. The RMS of claim 8 where the number of times an advertisement is sent to a receiving device is content triggered.

11. The RMS of claim 1 where the end-user receives advertisements based upon his viewing habits.

12. The RMS of claim 1 where the end-user received advertisements based upon requesting certain types of advertisements.

13. The RMS of claim 12, where the RMS flags such viewers as highly desirable and charges a premium for ads sent to such viewers.

14. The RMS of claim 1 where the end-user can subscribe to receive personalized co-cast content.

15. The RMS of claim 14 where the personalized content is based upon the end-users' user preferences.

16. The RMS of claim 14 where the personalized content is based on the end-users' viewing habits.

17. The RMS of claim 14 where the end-user can opt-out of receiving commercials on his television set.

18. The RMS of claim 1 where the RMS obtains information regarding the end-users travel habits and sends advertisements based upon the end-user's travel habits.
